(19) United States
(12) Patent Application Publication
(10) Pub. No.: US 2014/0155117 A1
(43) Pub. Date: Jun. 5, 2014

(54) Shaping Table Reconfiguration At Communication Event Boundaries

(71) Applicant: Broadcom Corporation, Irvine, CA (US)

(72) Inventors: Ying Xia, Saratoga, CA (US); Gowrisankar Somichetty, Bangalore (IN); Bongseok Park, Pleasanton, CA (US); Sriram Rajagopal, Bangalore (IN); Sriraman Dakshinamurthy, San Jose, CA (US); Robert Gustav Lorenz, Menlo Park, CA (US)

(21) Appl. No.: 13/923,902

(22) Filed: Jun. 21, 2013

Related U.S. Application Data
(60) Provisional application No. 61/804,537, filed on Mar. 22, 2013.
(60) Provisional application No. 61/732,780, filed on Dec. 3, 2012.

(51) Int. Cl. H04W 52/54

(52) U.S. Cl. CPC H04W 52/54
USPC 455/522

(57) ABSTRACT

A communication device, such as a smart phone, receives a power specification message from a network controller. The power specification message specifies an output power applicable for a particular communication subframe or symbol within the subframe. In response to the power specification message, the communication device determines a new shaping table and replaces an existing shaping table with the new shaping table. The communication device uses the shaping table to generate an envelope signal for an envelope tracking power supply, and the new shaping table is adapted to provide power saving operation at the specified output power.

### CROSS REFERENCE TO RELATED APPLICATIONS

This application claims priority to U.S. Provisional Application Ser. No. 61/732,780, filed 3 Dec. 2012, which is incorporated by reference in its entirety. This application also claims priority to, and incorporates by reference, U.S. Provisional Application Ser. No. 61/804,537, filed 22 Mar. 2013.

### TECHNICAL FIELD

This disclosure relates to signal transmission. This disclosure also relates to the transmit circuitry in user equipment such as cellular telephones and other devices.

### BACKGROUND

Rapid advances in electronics and communication technologies, driven by immense customer demand, have resulted in the widespread adoption of mobile communication devices. The extent of the proliferation of such devices is readily apparent in view of some estimates that put the number of wireless subscriber connections in use around the world at over 85% of the world's population. Furthermore, past estimates have indicated that (as just three examples) the United States, Italy, and the UK have more mobile phones in use in each country than there are people even living in those countries. Improvements in wireless communication devices, particularly in their ability to reduce power consumption, will help continue to make such devices attractive options for the consumer.

### BRIEF DESCRIPTION OF THE DRAWINGS

The innovation may be better understood with reference to the following drawings and description. In the figures, like reference numerals designate corresponding parts throughout the different views.

FIG. 1 shows an example of user equipment that includes a transmit and receive section.

FIG. 2 is an example of a transmit and receive section.

FIG. 3 shows examples of communication events for which shaping tables may be modified.

FIG. 4 shows an example of determining a new shaping table data set in response to a commanded output power for a specific communication event.

FIG. 5 shows logic for making modifications to a shaping table based on configuration parameters such as output power, and in response to communication events such as subframe boundaries and symbol boundaries.

FIG. 6 shows an additional example of a communication event for which shaping tables may be modified.

### DETAILED DESCRIPTION

The discussion below makes reference to user equipment. User equipment may take many different forms and have many different functions. As one example, user equipment may be a 2G, 3G, or 4G/LTE cellular phone capable of making and receiving wireless phone calls, and transmitting and receiving data. The user equipment may also be a smartphone that, in addition to making and receiving phone calls, runs any number or type of applications. User equipment may be virtually any device that transmits and receives information, including as additional examples a driver assistance module in a vehicle, an emergency transponder, a pager, a satellite television receiver, a networked stereo receiver, a computer system, music player, or virtually any other device. The techniques discussed below may also be implemented in a base station or other network controller that communicates with the user equipment.

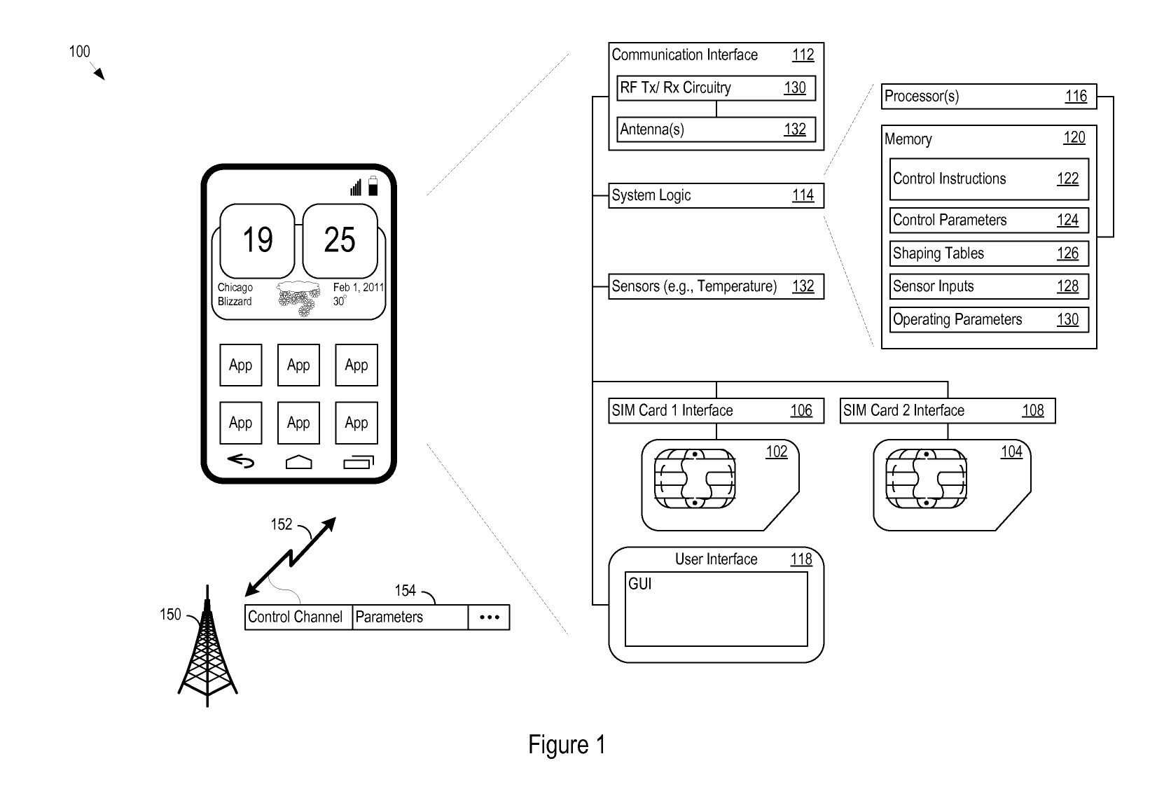

FIG. 1 shows an example of user equipment (UE) 100 in communication with a network controller 150, such as an enhanced Node B (eNB) or other base station. In this example, the UE 100 supports one or more Subscriber Identity Modules (SIMs), such as the SIM1 102 and the SIM2 104. An electrical and physical interface 106 connects SIM1 102 to the rest of the user equipment hardware, for example, through the system bus 110. Similarly, the electrical and physical interface 108 connects the SIM2 to the system bus 110.

The user equipment 100 includes a communication interface 112, system logic 114, and a user interface 118. The system logic 114 may include any combination of hardware, software, firmware, or other logic. The system logic 114 may be implemented, for example, in a system on a chip (SoC), application specific integrated circuit (ASIC), or other circuitry. The system logic 114 is part of the implementation of any desired functionality in the UE 100. In that regard, the system logic 114 may include logic that facilitates, as examples, running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 118. The user interface 118 may include a graphical user interface, touch sensitive display, voice or facial recognition inputs, buttons, switches, speakers and other user interface elements.

In the communication interface 112, Radio Frequency (RF) transmit (Tx) and receive (Rx) circuitry 130 handles transmission and reception of signals through the antenna(s) 132. The communication interface 112 may include one or more transceivers. The transceivers may be wireless transceivers that include modulation/demodulation circuitry, digital to analog converters (DACs), shaping tables, analog to digital converters (ADCs), filters, waveform shapers, pre-amplifiers, power amplifiers and/or other logic for transmitting and receiving through one or more antennas, or through a physical (e.g., wireline) medium.

As one implementation example, the communication interface 112 and system logic 114 may include a BCM2091 EDGE/HSPA Multi-Mode, Multi-Band Cellular Transceiver and a BCM59056 advanced power management unit (PMU), controlled by a BCM28150 HSPA+ system-on-a-chip (SoC) baseband smartphone processer or a BCM25331 Athena (™) baseband processor. These devices or other similar system solutions may be extended as described below to provide the additional functionality described below. These integrated circuits, as well as other hardware and software implementation options for the user equipment 100, are available from Broadcom Corporation of Irvine California.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interface 112 may support transmission and reception under the 4G/Long Term Evolution (LTE) standards. The techniques described below, however, are applicable to other communications technologies whether arising from the 3rd Generation Partnership Project (3GPP), GSM (R) Association, Universal Mobile Telecommunications System (UMTS), High Speed Packet Access (HSPA)+, or other partnerships or standards bodies.

The system logic 114 may include one or more processors 116 and memories 120. The memory 120 stores, for example, control instructions 122 that the processor 116 executes to carry out any of the processing or control functionality described below, operating in communication with the logic in the communication interface 112. For example, the system logic 114 may reprogram, adapt, or modify parameters or operational characteristics of the logic in the communication interface 112. The system logic 114 may make adaptations to, as a specific example, a shaping table in the communication interface 112.

The control parameters 124 provide and specify configuration and operating options for the control instructions 122. As will be explained in more detail below, the memory 120 may also store a library of data sets that represent shaping tables 126 and sensor inputs 128, as well as operating parameters 130 received from the network controller 150. The sensor inputs 128 may include a temperature obtained from the temperature sensor 132, or other inputs from other sensors. The UE 100 may reprogram a given shaping table with another data set from the library based on commanded output power and in response to communication events. The new shaping table appropriate for a particular output power may also be influenced by temperature (or other sensor inputs), as well as the operating parameters 130, including bandwidth specified by the network controller 150, closed loop power correction values, and other power parameters sent by the network controller 150.

As noted above, the UE 100 is in communication with the network controller 150 over one or more control channels 152. The network controller 150 sends messages to the UE 100 over the control channels 152. The messages may include operating parameters 154, such as power control parameters, bandwidth allocation parameters, and other operating parameters. The operating parameters 154 may include, for example, commanded output power levels for the UE for any upcoming frame, subframe, symbol or other communication event. As a specific example, the network controller 150 may specify an output power level for the UE for sending the next Sounding Reference Symbol (SRS) in a subframe of an LTE frame. In some implementations, such as LTE implementations, the network controller 150 may send operating parameters 154 such as center frequency, transmit channel selection, path loss compensation factors, UE specific parameters, UE specific modulation and coding information, and closed loop correction values, from which the UE 100 determines its output power. The UE 100 may respond to messages that include such operating parameters within a particular time window, e.g., within four LTE subframes (4 ms) from when the network controller 150 sent the message.

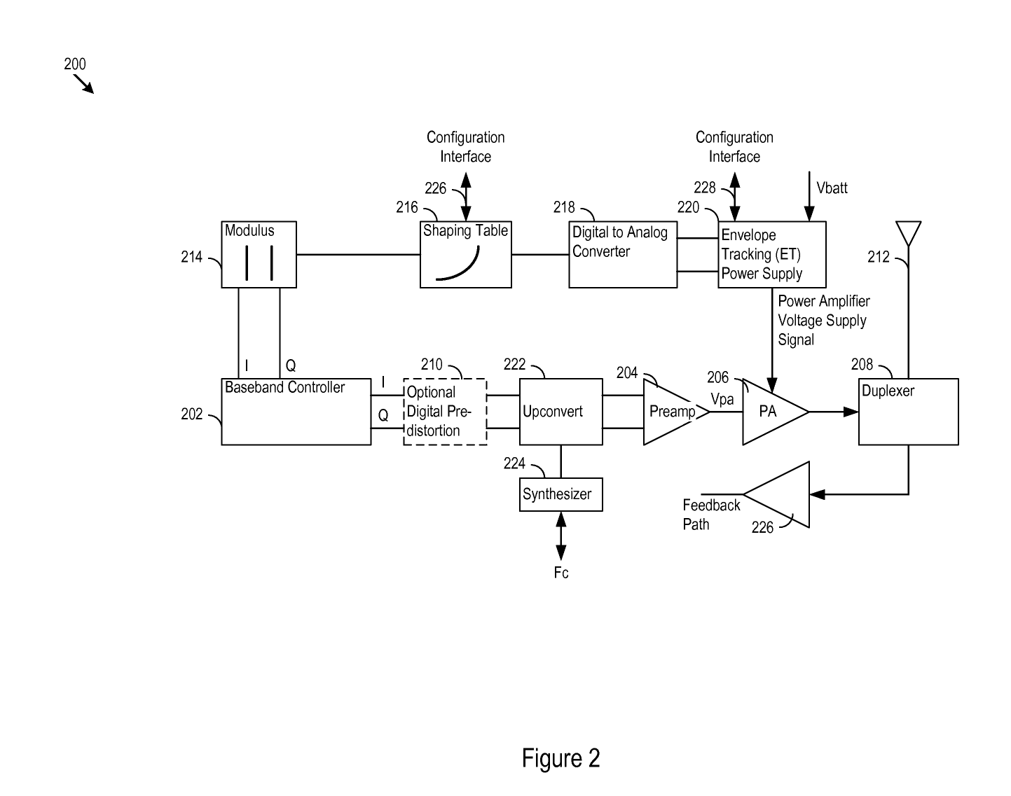

FIG. 2 shows an example of a transmit/receive logic 200 that may be present in the user equipment 100. The logic 200 may include a baseband controller, RF IC, power amplifier, and envelope tracking power supply, and other circuitry. Accordingly, the chain 200 may span portions of the Tx/Rx circuitry 130 and the system logic 114.

The logic 200 shown in FIG. 2 includes a baseband controller 202, a preamplifier 204, a power amplifier (PA) 206, and a duplexer 208. Pre-distortion logic 210 is optionally present, and may modify the input signal samples from the baseband controller prior to generation of the preamplifier output signal to the PA 206. An upconversion section 222 prepares the input signal samples for transmission. The upconversion section 222 may center the signal to be transmitted at a particular center frequency Fc. Different center frequencies for transmitting and for receiving may be specified over a control channel by a base station (for example), and internally generated by a frequency synthesizer 224 for upconversion and downconversion in the logic 200. The upconversion section 222 may implement a processing flow for the input signal samples that includes, as examples, a pre-emphasis or baseband gain stage, I and Q DACs, analog filters, and mixers for upconversion to Fc. Pre-amplification by the pre-amplification stage 204, and power amplification by the PA 206 may follow.

The duplexer 208 may implement a transmit/receive switch under control of the system logic 114. In one switch position, the duplexer 208 passes amplified transmit signals through the antenna 212. In a different switch position, the duplexer 208 passes received signals from the antenna 212 to the feedback path 226.

The baseband controller 202 may be part of the system logic 114 and provides, e.g., inphase/quadrature (I/Q) input signal samples to the modulus logic 214. The modulus logic 214 may output the absolute value (e.g., the square root of I squared plus q squared) of the input signal to a shaping table 216. The shaping table 216 maps input values to output values in a linear or non-linear manner. The output of the shaping table 216 feeds the digital to analog converter (DAC) 218. In turn, the DAC 218 outputs the envelope of the input signal as modified by the shaping table to the envelope tracking (ET) power supply 220. Said another way, the shaping table 216 implements a non-linear mapping between the modulus of the signal to be transmitted and the voltage that appears at the output of the DAC 218, to which the ET switcher is responsive.

The shaping table 216 may be implemented in many ways. For example, the shaping table may be a lookup table implemented in software or hardware. The shaping table 216 may include, for instance, 64 or 128 table data set values that map input signal values to output signal values. The shaping table implementation may perform linear or non-linear interpolation between specific data set values, for any input signal value that does not exactly correspond to one of the sample points having a specific data set value in the shaping table 216. In other implementations, the shaping table 216 may be implemented as program instructions that calculate the output value as a function of input signal value according to any desired input to output relationship curve.

Configuration interfaces 226 and 228, e.g., serial or parallel data interfaces, control pins, or other interfaces, may be provided to configure the shaping table 216 and ET 220, or other parts of the user equipment 100. The configuration interfaces 226 and 228 may be MIPI Alliance specified interfaces or other types of interfaces.

An envelope tracking power supply (ET) 220 receives the envelope signal from the DAC 218. The ET 220 may output a PA power supply voltage signal that follows the envelope signal, plus a preconfigured amount of headroom. The PA power supply voltage signal provides power to the PA 206 for driving the antenna 212 with the transmit signal.

The logic 200 may support a wide range of output powers. The output power employed at any particular time may be specified by a base station, for example. In some implementations, the logic 200 may generate output powers at the antenna 212 of 23 dBm. As noted above, the duplexer 208 may separate the transmit path and receive path, and in doing so introduces some power loss, typically on the order of 3 dBm. Thus, to achieve 23 dBm output power at the antenna 212, the PA 206 produces approximately a 26 dBm signal. Doing so, however, consumes a significant amount of power due to inefficiencies in the components of the logic 200. In particular, the PA 206 itself may be on the order of 40% efficient. Given these losses, certain techniques are described below that result in significant power savings for the device 100.

Specifically, the logic 200 may implement reprogramming of the shaping table 216 in response to particular events. The reprogramming carried out (e.g., the particular shaping table data set programmed into the shaping table) may vary according to the output power commanded of the device 100 by the network controller 150, or according to other operational parameters specified by the network controller 150. The events may include, as examples, the occurrence of communication frame boundaries, subframe boundaries, and symbol boundaries within frames and subframes. Said another way, the logic 200 may reconfigure the shaping table 216 as a function of output power, synchronously or asynchronously with respect to frame, subframe, and symbol boundaries. The frames and subframes may be, as examples, LTE frames (e.g., 10 ms frames) and subframes (e.g., 1 ms subframes). The adaptation of the shaping table 216 may result in significant power savings for the reasons described below.

As a specific example, the UE 100 (e.g., a smart phone) may include a baseband controller and a shaping table. The shaping table modifies input signal samples to provide envelope tracking signals characterized by a signal envelope. The UE 100 also includes an envelope tracking (ET) power supply that receives the envelope tracking signals and outputs a power supply voltage signal that approximates the signal envelope. A power amplifier receives the power supply voltage signal and drives a transmit antenna. In this system, the baseband controller obtains the input signal samples corresponding to a desired transmit signal, and provide the input signal samples to the shaping table. The baseband controller also determines an upcoming communication event, and responds to the upcoming communication event by determining a modification to the shaping table for handling the upcoming communication event. The baseband controller applies the modification to the shaping table in preparation for the upcoming communication event.

In some implementations, the baseband controller determines the upcoming communication event by receiving a power control message from a network controller. The power control message may include, as examples, a commanded output power, or operating parameters that determine an output power, at which to drive the transmit antenna, and a communication subframe at which the commanded output power is required. The baseband controller may then determine the modification by searching a library of shaping tables to locate a shaping table data set applicable to the commanded output power for the communication subframe, and may apply the modification by loading the shaping table data set into the shaping table.

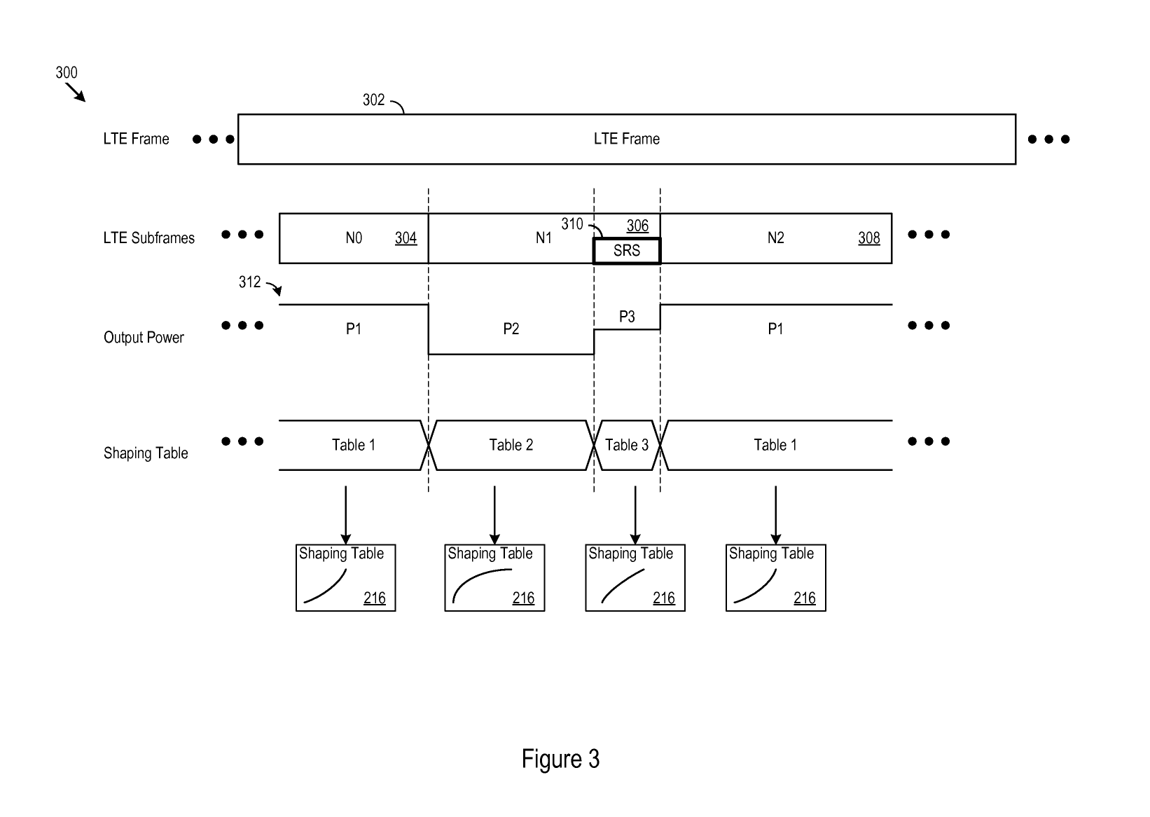

FIG. 3 shows examples of communication events 300 for which the UE 100 may modify shaping tables. The examples in FIG. 3 are in the context of an LTE system, but the communication events may be events that occur in any of wide range of communication systems and protocols. FIG. 3 shows an LTE frame 302 and several 1 ms subframes of the LTE frame 302. The subframes shown in FIG. 3 include the subframe 304, 306, and 308. Subframe 306 includes an SRS 310 that the UE will transmit to the network controller 150.

FIG. 3 also shows how the UE 100 may adapt its output power 312 in response to communication events, that are in this example the occurrence of subframe and symbol boundaries. In particular, FIG. 3 shows that the UE 100 is at power P1 during subframe 304, then switches to output power P2 for subframe 306. Further, within subframe 306, the UE 100 switches to output power P3 for the SRS 310, and then returns to output power P1 for the subframe 308.

The UE 100 switches its output power by configuring one or more functional blocks in the logic 200. For example, the UE 100 may adjust the gain of the preamplifier 204 or logic associated with the RF IC, may apply gain to the digital signal samples (e.g., by digital pre-distortion 212), or in other ways. The net result is that the UE 100 applies to the antenna 212 a transmit signal with the required output power.

The amount of power consumed to produce a given output power depends, to large extent, on the PA 206. The ET power supply 220 produces the power amplifier voltage supply signal based on the envelope of the signal input to the ET power supply 220. In turn, the envelope depends on the effect of the shaping table 216 on the signal samples input to the shaping table 216. Some shaping tables are more power efficient than others for specific output powers. Accordingly, the logic 200 may modify the shaping table 216 responsive to the required output power, such as the output powers P1, P2, and P3, and responsive to communication events, including subframe or symbol boundaries.

FIG. 3 shows that, responsive to the communication events, the logic 200 implements different shaping tables. Specifically, FIG. 3 shows that the logic 200 implements shaping table 1 during the subframe 304, and the shaping table 2 for a portion of the subframe 206. In the subframe 306, the logic 200 implements the shaping table 3 for transmission of the SRS at the output power P3, and returns to shaping table 1 for the subframe 308 and output power P1.

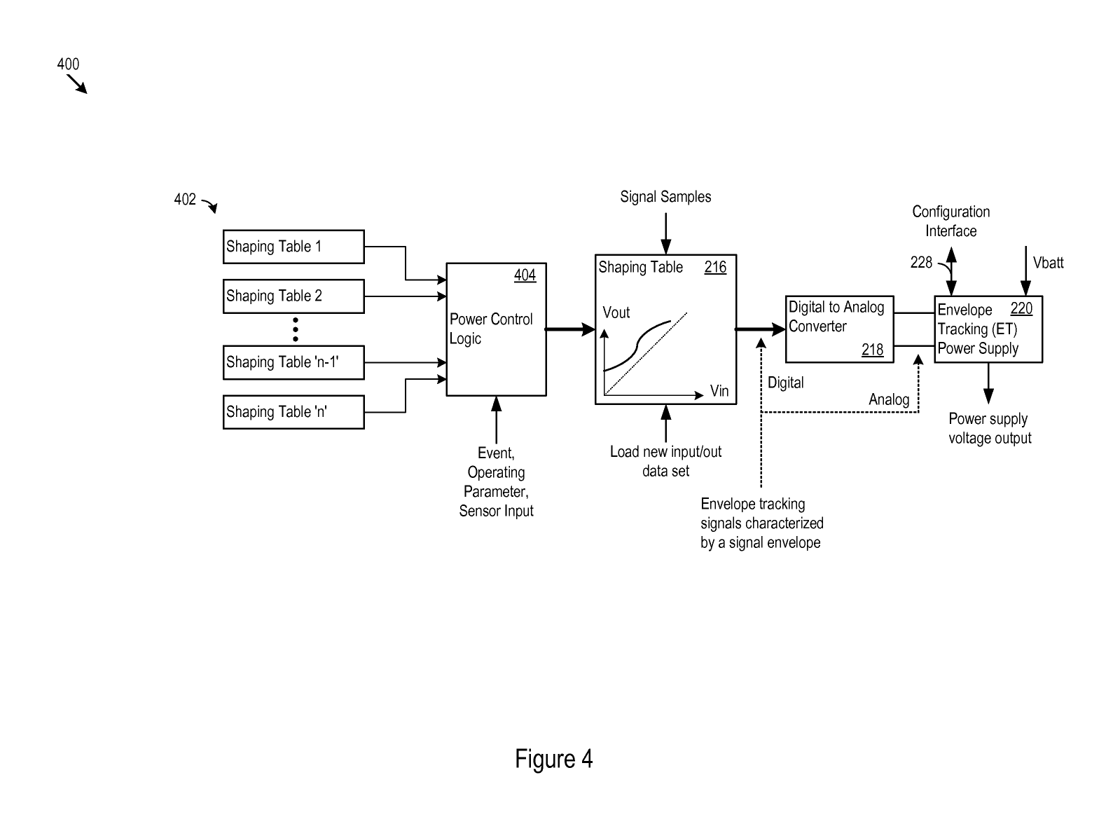

FIG. 4 shows another view of logic 400 for determining a new shaping table data set in response to a commanded output power for a specific communication event. A library 402 of shaping tables provides several different shaping table options, for any desired combination of output power, bandwidth allocation, and other operating parameters. The shaping tables may be determined in advance by computer simulation as those shaping tables that provide power saving benefits at multiple different output powers. The simulation may sweep over any desired number of output powers and shaping table configurations to find those that result in the best power consumption at any given output power. The library 402 may provide, for example, a different shaping table at any particular output power granularity, such as in steps of 2 dBm or some other granularity. The set of shaping tables in the library 402 recognizes that using a shaping table optimized for a particular output power at a different (e.g., lower) output power, will not result in optimal power efficiency.

The power control logic 404 accepts several inputs, such as the communication event (e.g., an upcoming SRS), operating parameters (e.g., commanded output power), and sensor inputs (e.g., temperature). The power control logic 404 may be implemented in hardware, software, or both to determine, given the inputs, how to configure the logic 200 to achieve the commanded output power. Furthermore, the power control logic 404 may select, given the commanded output power, a shaping table form the library 402 that achieves any desired power goal. The power goal may be consuming the least amount of energy, for example, given the commanded output power, or may be reducing power consumption by more than a threshold amount, given the commanded output power.

When the power control logic 404 will modify the shaping table 216, the power control logic 404 first obtains the new shaping table from the library 402. The power control logic 404 then reprograms the shaping table 216 with the input/output relationship represented by the new shaping table. As examples, reprogramming may be done by replacing lookup table data set values in non-volatile memory, or by replacing a calculation function in memory with a new function. The new shaping table then outputs envelope tracking signals characterized by a signal envelope for the DAC 218 which feeds the ET power supply 220. The power supply voltage output of the ET power supply 220 may then result in more power efficient operation at the commanded output power, than if the shaping table were not modified.

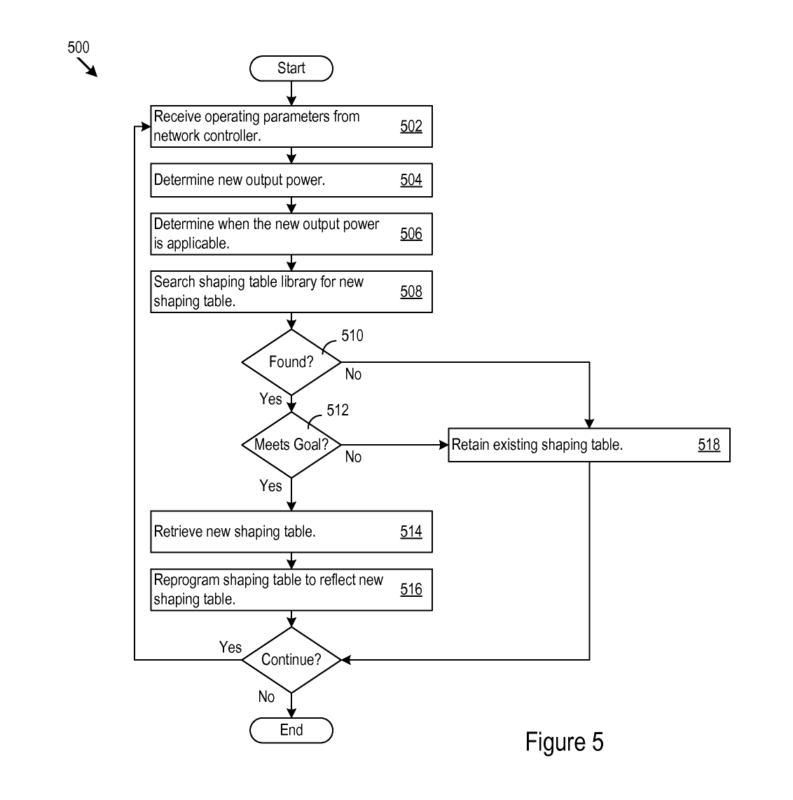

FIG. 5 shows logic 500 for making modifications to a shaping table based on configuration parameters such as output power, and in response to communication events such as subframe boundaries and symbol boundaries. The logic 500 may be implemented in one or more software layers in the UE 100, in software and firmware, for example as part of the control instructions 122. The logic 500 receives operating parameters 154 from the network controller 150 (502). The operating parameters 154 may lead to output power changes, to bandwidth allocation changes, or any other operational change for the UE 100.

The UE 100 determines a new output power (504), and when the new output power is applicable (506). The new output power may be applicable for the next subframe, the next symbol within a subframe, or at some later subframe or symbol. In some implementations, the operating parameters 154 may specify when the output power should change, and in other implementations, the UE 100 may assume that the output power should change after a specific delay, e.g., at the next subframe, or at some other later time.

The logic 500 also searches the shaping table library 402 for a new shaping table commensurate with the new output power (508). For example, the library 402 may include shaping tables at increments of 2 dBm of output power, and the logic 500 may determine whether the new output power is different enough to make a transition to a new shaping table. If a shaping table is found (510), the logic 500 may further determine whether the new shaping table meets a goal (512). The goal may be a power saving goal, such that the new shaping table would save more than a power saving threshold amount of power for transmission at the new output power compared to the existing shaping table. In other words, while there may be a different shaping table available in the library that can save some power, the power saving may not be significant enough to warrant reprogramming of the shaping table 216. The logic 500 may implement other goals as well.

If no appropriate shaping table is found (510), or the shaping table that is found does not meet the goals (512), then the logic 500 may retain the existing shaping table (518). Otherwise, the logic 500 retrieves the new shaping table (514), and reprograms the shaping table 216 with the newly selected shaping table (516).

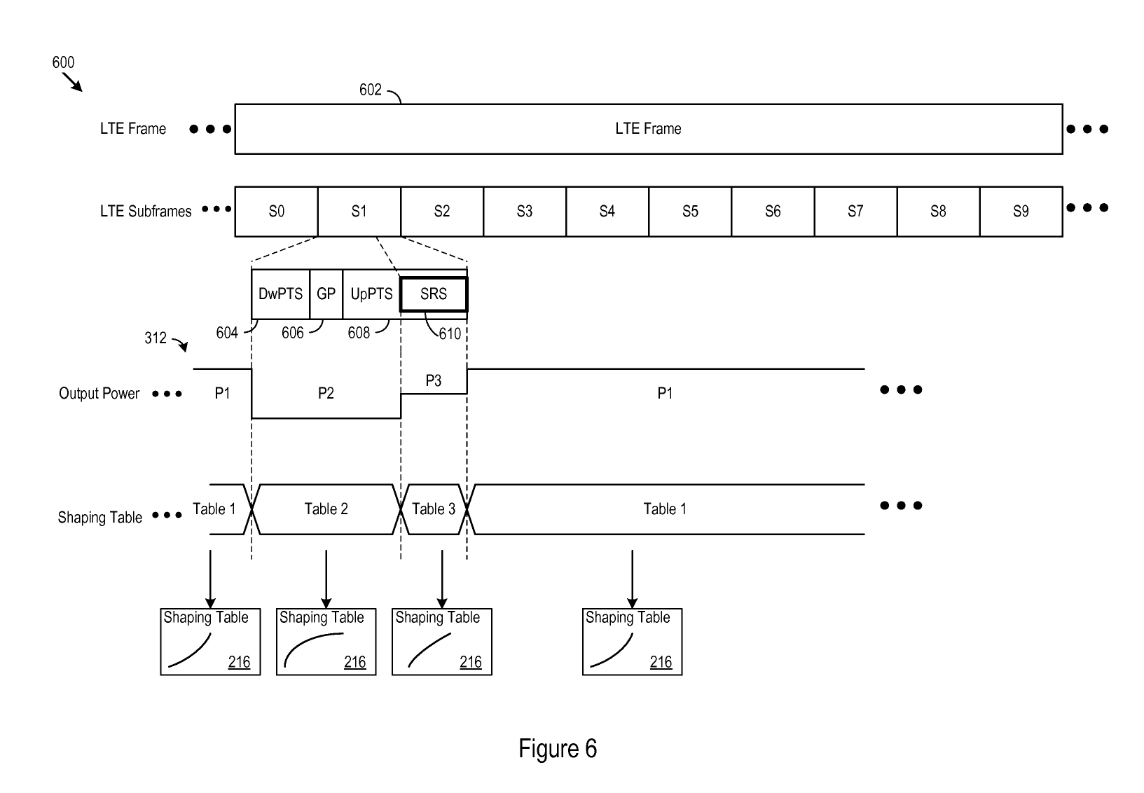

FIG. 6 shows an additional example 600 of communication events for which shaping tables may be modified. The techniques described apply to both Time Domain Duplexing (TDD) and Frequency Domain Duplexing (FDD). For FDD, uplink and downlink are transmitted on different center frequencies. For TDD, the downlink and the uplink may be on the same frequency, with the separation done in the time domain. While FIG. 3 showed an example of FDD operation, with the SRS symbol 310 occurring at the end of the LTE subframe (e.g., as the last symbol of a 1 ms subframe), FIG. 6 shows an example 600 of TDD operation.

In TDD operation, a 10 ms LTE frame 602 may be apportioned into ten (10) 1 ms subframes S0-S9, and each may be further subdivided into two slots, except for S1 and S6. The subframe S1 and S6 may include these fields: Downlink Pilot Time Slot (DwPTS) 604, Guard Period (GP) 606 and Uplink Pilot Time Slot (UpPTS) 608. The UpPTS 608 may have a one symbol duration and carry the SRS, or the UpPTS 608 may have a two symbol duration and carry an SRS, or an SRS and a short random access preamble. FIG. 6 shows an SRS symbol 610.

In FIG. 6, the shaping table 216 changes in response to communication events. In FIG. 6, these events include subframe boundaries. As one example, the shaping table 216 changes from table 1 to table 2, at the transition from S0 to S1 in response to the output power changing from P1 to P2. A similar change happens from table 3 to table 1 again when the output power returns to P1 at the transition from S1 to S2. Note, however, that FIG. 6 also shows that the shaping table 216 may change on other than a subframe basis and on other than a slot basis. In particular, in the example in FIG. 6, the shaping table 216 changes from table 2 to table 3 when the output power changes from P2 to P3 for transmitting the SRS symbol 610 (which may have a one or two symbol duration) in the uplink. In other words, shaping table changes may happen responsive to communication events, and the changes need not be constrained to any particular frame or symbol structure or timing.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a shaping table operable to modify an input signal to produce an output signal;
a power supply interface operable to communicate the output signal to a power supply; and
a controller operable to:
determine that an event is upcoming;
determine a modification to the shaping table responsive to the event; and
implement the modification to the shaping table for the event.

2. The system of claim 1, where the event comprises occurrence of a communication signal boundary.

3. The system of claim 2, where the communication signal boundary comprises a subframe boundary within a larger communication frame.

4. The system of claim 2, where the communication signal boundary comprises a symbol boundary within a larger communication frame.

5. The system of claim 1, where the controller is further operable to:
receive, from a network controller, an operational parameter; and where:
the controller is further operable to determine the modification responsive to the event and to the operational parameter.

6. The system of claim 5, where the operational parameter comprises a transmit power.

7. The system of claim 5, where the operational parameter comprises a transmit power commanded by the network controller for the event.

8. The system of claim 5, where the operational parameter comprises a wireless communication output power for the event; and where the event comprises occurrence of an upcoming subframe in a larger communication frame.

9. The system of claim 1, further comprising:
an envelope tracking power supply in communication with the power supply interface, the envelope tracking power supply operable to:
receive the output signal; and
generate a power supply voltage signal that approximates an envelope of the output signal.

10. A method comprising:
in user equipment:
receiving a power specification message from a network controller, the power specification message specifying an output power;
determining a new shaping table in response to the output power;
replacing an existing shaping table with the new shaping table; and
generating an envelope signal for a power supply with the new shaping table.

11. The method of claim 10, where receiving comprises:
receiving a power specification message that also specifies an upcoming communication event to which the output power is applicable.

12. The method of claim 11, where replacing further comprises:
replacing the existing shaping table with the new shaping table prior to the communication event.

13. The method of claim 10, where receiving comprises:
receiving a power specification message that also specifies a subframe boundary within a larger communication frame to which the output power is applicable.

14. The method of claim 10, where receiving comprises:
receiving a power specification message that also specifies a symbol within a larger communication frame to which the output power is applicable.

15. The method of claim 14, where the symbol comprises an uplink quality estimation symbol.

16. The method of claim 14, where the symbol comprises an uplink quality estimation symbol; and
sending the uplink quality estimation symbol to the network controller at the output power.

17. The method of claim 10, where determining comprises:
searching in a library of predefined shaping tables for the new shaping table applicable at the output power; and
retrieving from the library the new shaping table.

18. A system comprising:
a baseband controller;
a shaping table in communication with the baseband controller, the shaping table operable to modify input signal samples to provide envelope tracking signals characterized by a signal envelope;
an envelope tracking power supply operable to receive the envelope tracking signals and output a power supply voltage signal that approximates the signal envelope; and
a power amplifier operable to receive the power supply voltage signal and drive a transmit antenna; where:
the baseband controller is operable to:
obtain the input signal samples corresponding to a desired transmit signal;
provide the input signal samples to the shaping table;
determine an upcoming communication event;
respond to the upcoming communication event by determining a modification to the shaping table for handling the upcoming communication event; and
apply the modification to the shaping table in preparation for the upcoming communication event.

19. The system of claim 18, where the baseband controller is further operable to:
determine an output power for driving the transmit antenna; and
determine the modification responsive to the output power.

20. The system of claim 18, where the baseband controller is operable to determine the upcoming communication event by:
receiving a power control message from a network controller, the power control message comprising:
a commanded output power at which to drive the transmit antenna; and
a communication subframe at which the commanded output power is required; and
where the baseband controller is further operable to determine the modification by:
searching a library of shaping tables to locate a shaping table data set applicable to the commanded output power for the communication subframe; and
apply the modification by loading the shaping table data set into the shaping table.
